(19) United States
(12) Patent Application Publication
(10) Pub. No.: US 2008/0148719 A1
(43) Pub. Date: Jun. 26, 2008

(54) ENGINE SYSTEM AND A METHOD FOR A COMBUSTION INHIBITION REGENERATION OF AN EXHAUST GAS TREATMENT DEVICE IN A SUCH SYSTEM

(76) Inventors: Jonas Hermansson, Lindome (SE); Niklas Vollmer, Asa (SE); Anders Holger Johnsson, Goteborg (SE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/962,287

(22) Filed: Dec. 21, 2007

(30) Foreign Application Priority Data
Dec. 22, 2006 (EP) 06127162.3

(51) Int. Cl. F01N 3/00; F02D 17/02

(52) U.S. Cl. 60/295; 60/285; 701/103; 123/481

(57) ABSTRACT

A method and a system for regenerating an exhaust gas treatment device in an internal combustion engine having at least one cylinder are presented. The method comprises regenerating the device by inhibiting combustion in at least one of the engine cylinders and controlling the fuel injection system so that fuel is allowed into at least one of the cylinders in which combustion is inhibited.

### TECHNICAL FIELD

The present invention relates to a method for regenerating an exhaust gas treatment device for an internal combustion engine comprising at least one cylinder and fuel injection system.

### BACKGROUND OF THE INVENTION

Modern vehicles are equipped with exhaust gas treatment devices, known as catalytic converters, that convert regulated substances such as hydrocarbons (HC), carbon monoxide (CO) and nitrogen oxides (NOx) into substances such as carbon dioxide (CO2), nitrogen (N2) and water (H2O). A known problem with catalytic converters is that certain substances can remain, for example by physical or chemical adsorption, on internal surfaces of the converters, and reduce the capacity of the converters. Such adsorption is known as catalytic converter poisoning. For example, fuels, whether gasoline or diesel, for vehicle internal combustion engines, contain a relatively high amount of sulfur, typically depending on in which state or region they are provided. The sulfur reduces efficiency of the catalyst exhaust gas treatment devices. In the engine combustion process, the sulfur is converted to sulfur oxides (SOx), which adsorbs strongly to internal surfaces of the catalyst and therefore reduces its exhaust gas treatment capacity. This process is often referred to as sulfur poisoning. Sulfur adsorption is particularly strong during low load driving conditions.

A number of catalytic converter regeneration measures to solve this problem have been suggested. It is well known that the catalytic converter can be restored from sulfur poisoning by being exposed to high temperatures.

The patent publication U.S. Pat. No. 6,161,377 suggests heating the catalytic converter by introducing secondary air into the exhaust gases, combined with providing a rich mixture to the cylinders. A disadvantage with this method is that it requires an additional component in the form of an air pump for the introduction of the secondary air. Apart from adding to the complexity and the cost of the engine system, such an air pump creates a noise, which can be disturbing to drivers and passengers in a vehicle in which the pump is installed. Further, a high exhaust gas pressure can give an excessive load to the air pump. Also, since air, according to said patent publication, is injected downstream of the engine, relatively close to the catalytic converter, there is a great possibility that the fuel and air will not be fully mixed when reaching the catalytic converter. This reduces the efficiency of the regeneration method, and can cause concentration of fuel, which may result in degradation of the catalytic converter.

The patent publication U.S. Pat. No. 6,901,749 discloses, in order to heat the catalytic converter, providing a rich mixture to the engine cylinders combined with adjusting the ignition timing so as to provide a relatively late ignition during the engine cycles. The idea is to allow combustion to continue in the exhaust conduit downstream of the engine cylinders in order to heat the catalytic converter. However, the proposed solution increases the fuel consumption. Also, since the energy for heating the catalytic converter is transported thermally, there are substantial energy losses between the engine and the catalytic converter in the form of temperature decrease. In the case of the catalytic converter being provided relatively far from the engine, the energy losses may be such that no, or an insufficient result is provided by the measure. Also, in the case of the engine system being equipped with an exhaust turbo charger, the energy losses at the delayed ignition regeneration measure are further increased.

### SUMMARY OF THE INVENTION

The present invention is directed to providing optimum efficiency of an exhaust gas treatment device of an internal combustion engine.

Accordingly, a method for regenerating an exhaust gas aftertreatment device for an internal combustion engine includes inhibiting combustion in at least one of the engine cylinders, and controlling fuel injection so that fuel is allowed into at least one of the cylinders in which combustion is inhibited.

By allowing fuel injection while combustion is inhibited, the fuel can be thoroughly mixed with air in the cylinder(s). The long transportation after the cylinder(s) enables improved mixing of the air and fuel before reaching the catalytic converter. This provides a homogonous distribution of fuel and air across the lateral extensions of the catalytic converter, in which the mixture is combusted so as to heat the exhaust gas treatment device. The result is a very effective regeneration, and minimizing risks of the regeneration measure causing damage to the catalytic converter. This thorough regeneration is provided simply by use of the fuel injection means, without the need for additional equipment in the engine system.

In addition, since the energy for heating the catalytic converter is transported chemically, i.e. in the air/fuel mixture, and converted to thermal energy in the catalytic converter, there are essentially no energy losses between the engine and the catalytic converter. Thus, the invention provides a very effective regeneration measure, even in a case where the catalytic converter is provided relatively far from the engine, and/or in the case of the engine system being equipped with a exhaust turbo charger.

The use of fuel injection while combustion is inhibited for heating exhaust gas treatment device makes the method advantageous for low load conditions, at which the exhaust gas treatment device temperature is relatively low, and sulfur adsorption in particularly strong.

In addition, in comparison to the regeneration measure involving ignition timing delay as described in said document U.S. Pat. No. 6,901,749, the combustion inhibition exhaust gas treatment device regeneration according to the invention provides has better results regarding fuel consumption, especially at relatively low exhaust gas treatment device temperatures. In addition, the regeneration according to the invention is a powerful measure providing a fast removal of sulfur deposits in the exhaust gas treatment device.

Preferably, the step of inhibiting combustion comprises controlling ignition at the cylinder so that combustion is inhibited. Thereby, the method is adapted to spark ignition engines, at which ignition is inhibited during at least one operative cycle of the cylinder(s) during which cycle fuel is allowed to the cylinder, which allows after-combustion of the air/fuel mixture, i.e. allows it to pass the cylinder(s) and the exhaust manifold, and to be combusted in the exhaust gas treatment device.

Alternatively or in addition to ignition inhibition, the combustion inhibition could comprise controlling at least one exhaust valve at least one of the cylinders into which fuel is allowed so as to reduce or eliminate an increase in pressure in the cylinder. Thereby, a valve control system, in itself known to the person skilled in the art, can be used to open the exhaust valve(s) when at a compression stroke of the cylinder the piston is moving from the bottom dead centre to the top dead center. Preferably, the method includes determining, during the combustion inhibition exhaust gas treatment device regeneration, a value of a control parameter corresponding to, or being related to a requested torque of the engine, the combustion inhibition exhaust gas treatment device regeneration being dependent on the control parameter value determination. Thereby, the combustion inhibition exhaust gas treatment device regeneration can be adjusted, for example as described below, to allow the engine to deliver the torque requested. This makes it possible to quickly respond to torque requests based on accelerator pedal maneuverings.

Preferably, where the internal combustion engine includes at least two cylinders, the number of cylinders in which combustion is inhibited is dependent on the control parameter value determination. Thereby, the combustion inhibition exhaust gas treatment device regeneration can be adjusted while being effected, so that it can continue while at the same time torque requirements within certain limits can be met. This is of great advantage in many vehicle operational situations, for example during extended periods of low torque requirements without fuel cut situations. Such conditions can occur for example where the vehicle is traveling for an extended period of time at a relatively low speed on a road with small or no variations in altitude, and the accelerator pedal is kept relatively still. This advantageous embodiment allows for combustion to take place in some of the cylinders to meet torque requirements, while the other cylinders are used for the combustion inhibition exhaust gas treatment device regeneration.

Preferably, the method further includes determining during the combustion inhibition exhaust gas treatment device regeneration the temperature of the exhaust gas treatment device, and terminating the combustion inhibition exhaust gas treatment device regeneration if it is determined that the temperature of the exhaust gas treatment device is above a predetermined temperature limit value. Thereby, temperatures that are high enough to cause thermal damage to the catalytic converter can be effectively avoided. It should be noted that avoiding too high catalytic converter temperatures is of important to preventing premature catalytic converter aging.

The invention is applicable to engines in which the fuel injection systems are adapted to inject fuel into an air inlet duct communicating with more than one cylinder or all cylinders, or to engines in which the fuel injection can be controlled individually for each cylinder. In the latter case, and where the engine comprises at least two cylinders, preferably the method further includes determining the temperature of the exhaust gas treatment device, the number of cylinders into which fuel is allowed while combustion is inhibited being dependent on the temperature of the exhaust gas treatment device. Thus, where ignition is inhibited in at least two of the cylinders, fuel can be injected in one or more of the cylinders in which ignition is inhibited, depending on the exhaust gas treatment device temperature. For example, if, during the regeneration, it is desired to decrease the exhaust gas treatment device temperature, the number of cylinders in which fuel is injected while ignition is inhibited can be decreased, and vice versa. Thus, a very advantageous manner of monitoring and controlling the exhaust gas treatment device temperature is provided, which gives excellent possibilities of obtaining a fast and powerful regeneration without the risk of damaging the exhaust gas treatment device.

In one embodiment, the method includes determining the temperature of the exhaust gas treatment device, the amount of fuel allowed into the at least one of the cylinders, in which combustion is inhibited, being controlled in dependence on the temperature of the exhaust gas treatment device. For example, if, during the regeneration, it is desired to decrease the exhaust gas treatment device temperature, the amount of fuel injected while ignition is inhibited can be decreased, and vice versa. The control of the injected amount of fuel provides an advantageous manner of monitoring and controlling the exhaust gas treatment device temperature. This control can be used individually, or in combination with said control of the number of cylinders into which fuel is allowed while combustion is inhibited. Thereby, the control of the number of cylinders into which fuel is allowed, while combustion is inhibited, can be used as for a coarse temperature control, and the control of the injected amount of fuel, in the respective cylinder in which fuel is allowed, can be used for a fine temperature control. This provides a fast and precise control of the exhaust gas treatment device temperature.

Preferably, the method includes controlling air flow so as to control the combustion in the exhaust gas treatment device during the combustion inhibition exhaust gas treatment device regeneration. By adjusting the air flow, for example based on the flow of fuel injected, it can be secured that a combustible air/fuel mixture is provided to the catalytic converter during the regeneration action. Also, controlling the combustion in the exhaust gas treatment device could comprise controlling a location or a region of a maximum temperature in the exhaust gas treatment device. Thereby, as explained closer below, the air flow can be used to control the temperature distribution in a longitudinal direction of the catalytic converter. By changing, during the sulfur regeneration, the location of the maximum temperature, it is possible to obtain a particularly thorough regeneration, since it can be secured that the temperature is increased sufficiently for sulfur deposit removal throughout the entire catalytic converter. Also, moving the maximum temperature in this way further reduces the risk of damaging the catalytic converter by high temperature exposure. Specially, the risk of excessive temperatures in an upstream end of the catalytic converter can be substantially reduced, so that catalytic converter damage can be effectively avoided.

### BRIEF DESCRIPTION OF THE DRAWINGS

Below, the invention will be described in detail with reference to the drawings, in which

FIG. 1 shows a schematic view of parts of a vehicle engine system;

FIG. 2 shows a block diagram depicting an example of a method for regenerating an exhaust gas aftertreatment device according to the present invention;

FIG. 3 shows a block diagram depicting an alternative example of a method according to the present invention; and

FIG. 4 is a schematic side view of a detail in FIG. 1 with temperature distribution curves.

### DETAILED DESCRIPTION

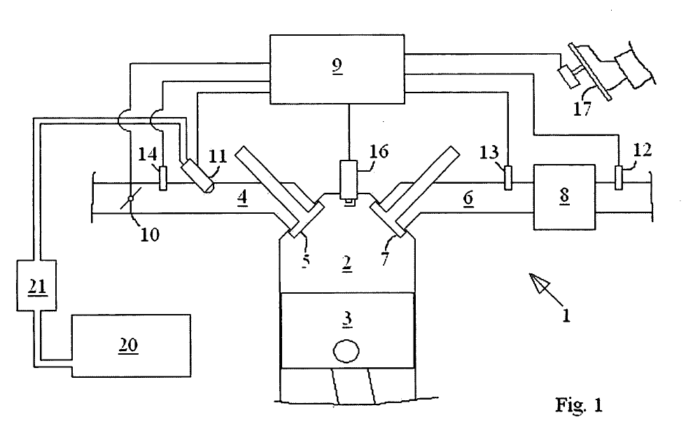

FIG. 1 shows a schematic view of parts of an exemplary vehicle engine system 1 comprising an internal combustion engine. The engine comprises four cylinders 2, of which only one is shown in FIG. 1, each with a reciprocating piston 3. It should be noted that the invention is applicable to engines with any number of cylinders. Communication between each cylinder 2 and an inlet duct 4 is controlled by at least one respective inlet valve 5, and communication between each cylinder 2 and an exhaust duct 6 is controlled by at least one respective exhaust valve 7. Downstream from the cylinders 2, an exhaust gas treatment device 8, in the form of a catalytic converter, is provided.

The engine system 1 also comprises an engine control unit (ECU) 9, which can be provided as one unit, or as more than one logically interconnected physical units. The ECU 9 is adapted to control air flow control system comprising a throttle valve 10, and fuel injection system 11 comprising at least one fuel injector 11 in the inlet duct 4. In this embodiment, where the engine presents more than one cylinder, the fuel injection can be controlled individually for each cylinder, by a fuel injector being provided at a separate portion of the inlet duct 4 communicating with the respective cylinder, (so called port fuel injection). Alternatively, as is known in the art, a fuel injector can be provided in each cylinder 2, (so called direct fuel injection). As a further alternative, one single fuel injector can be provided for more than one cylinder, or all cylinders, for example at an upstream portion of the inlet duct communicating with more than one cylinder, or all cylinders. The fuel injection system 11 communicates with fuel storage tank 20, via a fuel pump 21.

The ECU 9 is also adapted to receive signals from a downstream gas sensor 12 located downstream of the catalytic converter 8, as well as from an upstream gas sensor 13 located in the exhaust duct 6 between the cylinders 2 and the catalytic converter 8. The ECU 9 is adapted to determine, based on the signals from the first and second sensors 12, 13, the oxygen content in the exhaust gases upstream and downstream, respectively, of the catalytic converter 8. As is known in the art, the oxygen content in the exhaust gases is indicative of the lambda value of the air/fuel mixture provided to the engine.

In addition, the ECU 9 is also adapted to determine the engine air flow based on signals received from an air flow sensor 14 located in the inlet duct 4. As an alternative, as is known in the art, the air flow can be computed based on parameters such as the inlet manifold pressure, throttle position, engine speed, inlet temperature, and atmospheric pressure. Manners of determining the values of these parameters are known in the art, and not explained further here.

The ECU 9 is adapted to determine the temperature of the catalytic converter 8 based at least partly on the air flow, the lambda value, the ambient temperature, engine load, and engine rotational speed. As an alternative, the ECU 9 can be adapted to receive signals from a temperature sensor located in the exhaust duct 6 between the cylinders 2 and the catalytic converter 8, based on which signals, the catalytic converter temperature can be determined.

Further, at each cylinder, ignition system 16 comprising a spark plug 16 are provided and controllable individually by the ECU 9. In this example, the four cylinders of the engine are arranged in a straight line, and, numbering the cylinders according to their spatial sequence, the normal ignition sequence of the engine is 1-3-4-2.

The ECU is adapted to adjust, as known in the art, the value of a value of a control parameter in the form of a requested torque parameter based on signals from an accelerator pedal 17 in the vehicle. The ECU 9 is also adapted to compare the requested torque to a first and a second requested torque threshold value. In this exemplary embodiment, the first requested torque threshold value is positive, and the second requested torque threshold value is zero. If the accelerator pedal 17 is released, i.e. un-depressed, the requested torque is determined to be zero or negative.

The ECU 9 is adapted to determine, based at least partly on an analysis of a signal from the downstream gas sensor 12, the level of sulfur poisoning of the catalytic converter 8, and whether the catalytic converter 8 is subjected to sulfur poisoning, as described in the European patent application entitled “An internal combustion engine system and a method for determining a condition of an exhaust gas treatment device in a such a system”, filed by the applicant on the first filing date of the present application, and incorporated herein by reference.

Alternatively, the ECU 9 can be adapted to determine the level of sulfur poisoning of the catalytic converter 8, and whether the catalytic converter 8 is subjected to sulfur poisoning, by some alternative method. For example, a sulfur poisoning establishment procedure can include adjusting in the ECU 9 a sulfur oxide (SOx) adsorption counter, based on air-fuel ratio, engine operating condition, catalyst temperature, the engine rotational speed and the intake pressure.

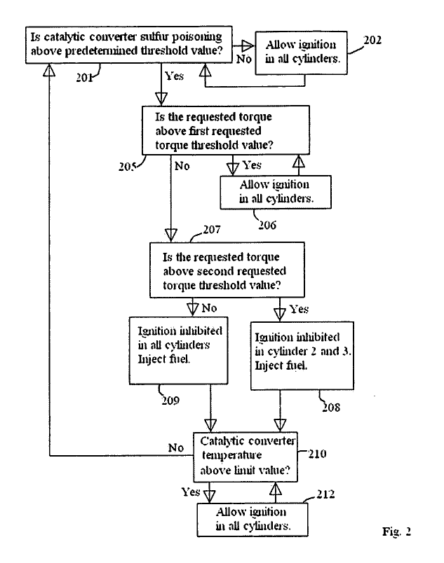

FIG. 2 depicts an exemplary method for regenerating an exhaust gas aftertreatment device according to the present invention. The ECU 9 determines 201 whether data corresponding to the level of sulfur poisoning of the catalytic converter is above a predetermined sulfur poisoning threshold value. If it is determined that the data corresponding to the level of sulfur poisoning is not above the sulfur poisoning threshold value, it is determined in 202 that no combustion inhibition sulfur regeneration action is carried out, i.e. ignition is allowed in all cylinders of the engine.

If it is determined that the data corresponding to the level of sulfur poisoning is above the sulfur poisoning threshold value, it is determined in 205 whether the requested torque is above the first requested torque threshold value. The first requested torque threshold value is chosen so that torque values at or below it correspond to positive, moderate torque values, sufficient for low load conditions. If it is determined that the requested torque is above the first requested torque threshold value, it is determined in 206 that no combustion inhibition sulfur regeneration action is carried out, i.e. ignition is allowed in all cylinders of the engine.

If it is determined that the requested torque is at or below the first requested torque threshold value, it is determined in 207 whether the requested torque is above the second requested torque threshold value. The second requested torque threshold value is chosen so that torque values at or below it correspond to zero or negative torque values, typically occurring at a release of the accelerator pedal 17.

If it is determined in 207 that the requested torque is above the second requested torque threshold value, the combustion inhibition sulfur regeneration action is carried out by inhibiting ignition in some of the cylinders, more specifically in cylinders no. 2 and 3, and allowing fuel injection into these cylinders in 208. Thereby, the air and fuel is transported from the cylinders no. 2 and 3, through the exhaust duct 6. The mixture reaches the catalytic converter 8 where it is combusted to increase the temperature of the converter 8 in order to eliminate sulfur deposits.

In cylinders no. 1 and 4, ignition is allowed, so that air and fuel injected can be combusted to meet output torque requirements. Thus, based on the determined value of the requested torque, ignition is allowed in only some of the cylinders, whereby the sulfur regeneration action can be carried out, while at the same time the requested torque is provided. This method is applicable to engines with two or more cylinders, and in some embodiments, the amount of cylinders in which ignition is activated can be dependent in the value of the requested torque.

If it is determined in 207 that the requested torque is at or below the second requested torque threshold value, the combustion inhibition sulfur regeneration action is carried out by inhibiting ignition and allowing fuel injection in all cylinders in 209. Thereby, the air and fuel is transported from all cylinders, through the exhaust duct 6, so that the mixture reaches the catalytic converter 8 where it is combusted to increase the temperature of the converter 8 in order to eliminate sulfur deposits.

Regardless whether the combustion inhibition sulfur regeneration action is carried out by inhibiting ignition in all cylinders in 209, or in only some of the cylinders in 208, during the regeneration action, the temperature of the catalytic converter 8 is monitored in 210 by the ECU 9, in a manner mentioned above. If the catalytic converter temperature rises above a predetermined temperature limit value in 210, the combustion inhibition sulfur regeneration action is terminated in 212 by allowing ignition by the ignition means 16. The ECU 9 continues to monitor in 213 the temperature of the catalytic converter 8, and if this temperature falls below the predetermined temperature limit value, it is again determined in 205 whether the requested torque is above the first requested torque threshold value, and the steps following this determination in 205, described above, are repeated.

As mentioned, the ECU 9 is adapted to determine the level of sulfur poisoning of the catalytic converter. Thereby, the ECU 9 can be adapted to terminate a regeneration action when the level of sulfur poisoning has been reduced to a predetermined level. Thus, referring to FIG. 2, during the combustion inhibition sulfur regeneration action, regardless whether it is carried out by inhibiting ignition in all cylinders in 209, or in only some of the cylinders in 208, the level of sulfur poisoning of the catalytic converter is determined in 201. If it is determined in 201 that the level of sulfur poisoning has been reduced to the predetermined level, the combustion inhibition sulfur regeneration action is terminated in 202 by allowing ignition in all cylinders.

Also, if the sulfur regeneration action is terminated, for example due to the catalytic converter temperature rising above the predetermined temperature limit value in 210, or due to a torque above a the first requested torque threshold value being requested in 205, the level of sulfur poisoning at the interruption of the regeneration action can be established. Thereby, the regeneration action can be “continued” in a suitable manner, once circumstances, as described above, allow such a “continuation” to take place.

Regardless whether the combustion inhibition sulfur regeneration action is carried out by inhibiting ignition in all cylinders in 209, or in only some of the cylinders in 208, during the combustion inhibition sulfur regeneration action, the requested torque is continuously monitored, in order to determine whether the requested torque has changed so that the combustion inhibition sulfur regeneration action has to be changed or terminated. In this embodiment, during the combustion inhibition sulfur regeneration action, the actual requested torque is continuously monitored and compared to the first and second requested torque threshold values. More specifically, it is continuously determined in 205 whether the requested torque, for example due to maneuvering of the accelerator pedal, is above the second requested torque threshold value.

Subsequently, similar to what has been described above, if it is determined that the requested torque is above the first requested torque threshold value, it is determined in 206 that the sulfur regeneration action is terminated by allowing ignition in all cylinders of the engine. If it is determined that the requested torque is at or below the first requested torque threshold value, it is determined in 207 whether the requested torque is above the second requested torque threshold value. If it is determined in 207 that the requested torque is above the second requested torque threshold value, the combustion inhibition sulfur regeneration action is carried out in 208 by inhibiting ignition in cylinders no. 2 and 3, and allowing ignition in cylinders no. 1 and 4. If it is determined in 207 that the requested torque is at or below the second requested torque threshold value, the combustion inhibition sulfur regeneration action is carried out by inhibiting ignition and allowing fuel injection in all cylinders in 209.

Thus, apart from terminating the regeneration action if needed, the monitoring of the requested torque allows for changing a regeneration action in view of requested torque changes. More specifically, if the requested torque is changed from zero, or a negative value, to a moderate positive value, a regeneration action involving ignition inhibition in all cylinders can be changed to a regeneration action involving ignition inhibition in only some of the cylinders. Contrarily, if the requested torque is changed from moderate positive value to zero, or a negative value, a regeneration action involving ignition inhibition in only some of the cylinders can be changed to a regeneration action involving ignition inhibition in all cylinders.

It should be noted that as an alternative to the requested torque, some other control parameter, related to the requested torque can be used as a basis for the determination whether to perform the combustion inhibition regeneration action. For example, the signal corresponding to the setting of the accelerator pedal, or a signal for controlling the fuel injection system 11 can be used instead of the requested torque parameter, since they are both related to the latter.

In the embodiment described above, the combustion inhibition exhaust gas treatment device regeneration can run in any of two “modes”, with combustion inhibited in all of the cylinders, or in two of the cylinders, depending on the requested torque. However, the number of such modes can be more than two. For example, in a four cylinder engine, combustion can be inhibited in one, two, three or all cylinders, where the number of cylinders in which combustion is allowed can be proportional to the requested torque. For instance, if the requested is higher that 0%, but lower than 25% of the maximum requested torque, combustion can be inhibited in three of the cylinders, if the requested is higher that 25%, but lower than 50% of the maximum requested torque, combustion can be inhibited in two of the cylinders, if the requested is higher that 50%, but lower than 75% of the maximum requested torque, combustion can be inhibited in one of the cylinders, and if the requested is higher that 75% of the maximum requested torque, combustion can allowed in all cylinders. Similar relations between the requested torque and the number of cylinders in which combustion is inhibited can be devised for engines with any number of cylinders, e.g. five, six, eight, etc.

Also, the number of cylinders in which combustion is inhibited can be dependent on the rotational speed of the engine. For example, assuming a constant requested torque, combustion can be inhibited in a relatively large number of cylinders at relatively high engine speeds, and combustion can be inhibited in a relatively small number of cylinders, or no cylinders, at relatively low engine speeds.

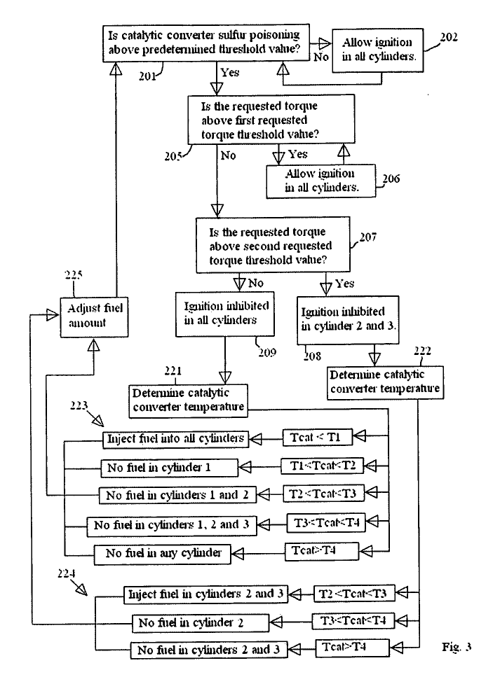

Reference is made to FIG. 3, showing an alternative embodiment according to the present invention. As in the embodiment described with reference to FIG. 2, the ECU 9 determines in 201 whether data corresponding to the level of sulfur poisoning of the catalytic converter is above a predetermined sulfur poisoning threshold value, and depending on this determination, it is determined in 202 that no combustion inhibition sulfur regeneration action is carried out, or it is determined in 205 whether the requested torque is above the first requested torque threshold value. Depending on the determination in 205 whether the requested torque is above the first requested torque threshold value, it is determined in 206 that no combustion inhibition sulfur regeneration action is carried out, or it is determined in 207 whether the requested torque is above the second requested torque threshold value.

In the embodiment depicted in FIG. 3, if it is determined in 207 that the requested torque is at or below the second requested torque threshold value, the combustion inhibition sulfur regeneration action is carried out by inhibiting ignition in all cylinders in 209. The temperature Tcat of the catalytic converter 8 is determined in 221, and based on the temperature, the number of cylinders with ignition inhibition in which fuel is to be injected is determined in 223.

If the catalytic converter temperature Tcat is below a first temperature threshold value T1, fuel is injected into all cylinders. If the catalytic converter temperature Tcat is above the first temperature threshold value T1 and below a second temperature threshold value T2, fuel is injected in all cylinders in which ignition is inhibited, except one of them, in this example cylinder no. 1. If the catalytic converter temperature Tcat is above the second temperature threshold value T2 and below a third temperature threshold value T3, fuel is injected in all cylinders in which ignition is inhibited, except two of them, in this example cylinders no. 1 and 2. If the catalytic converter temperature Tcat is above the third temperature threshold value T3 and below a fourth temperature threshold value T4, fuel is injected in all cylinders in which ignition is inhibited, except three of them, in this example cylinders no. 1, 2 and 3. If the catalytic converter temperature Tcat is above the fourth temperature threshold value T4, no fuel is injected into any of the cylinders in which ignition is inhibited. By controlling the number of cylinders in which fuel is injected during ignition inhibition, a coarse temperature control of the catalytic converter 8 is achieved.

Regardless of the number of cylinders in which fuel is injected during ignition inhibition, the amount of fuel injected in each cylinder with ignition inhibition is controlled in 225, so that a precise temperature control of the catalytic converter 8 is achieved.

If it is determined in 207 that the requested torque is above the second requested torque threshold value, the combustion inhibition sulfur regeneration action is carried out by inhibiting ignition in cylinders no. 2 and 3, in 208. The temperature Tcat of the catalytic converter 8 is determined in 222, and based on the temperature, the number of cylinders with ignition inhibition in which fuel is to be injected is determined in 224.

If the catalytic converter temperature Tcat is below the third temperature threshold value T3, fuel is injected in all cylinders in which ignition is inhibited, i.e. cylinders no. 2 and 3. If the catalytic converter temperature Tcat is above the third temperature threshold value T3 and below a fourth temperature threshold value T4, fuel is injected in all cylinders in which ignition is inhibited, except one of them, in this example cylinder no. 2. If the catalytic converter temperature Tcat is above the fourth temperature threshold value T4, no fuel is injected into any of the cylinders in which ignition is inhibited. Thereby, as in the case of ignition inhibition in all cylinders in 209, a coarse temperature control of the catalytic converter 8 is achieved.

Also, as in the case of ignition inhibition in all cylinders in 209, regardless of the number of cylinders in which fuel is injected during ignition inhibition, the amount of fuel injected in each cylinder with ignition inhibition is controlled in 225, so that a fine temperature control of the catalytic converter 8 is achieved.

Similar to the exemplary embodiment described with reference to FIG. 2, regardless whether the regeneration is carried out by inhibiting ignition in all cylinders in 209, or in only some of the cylinders in 208, the level of sulfur poisoning of the catalytic converter is determined in 201. If it is determined in 201 that the level of sulfur poisoning has been reduced to the predetermined level, the combustion inhibition sulfur regeneration action is terminated in 202 by allowing ignition in all cylinders.

Also, similar to the embodiment described with reference to FIG. 2, regardless whether the combustion inhibition sulfur regeneration action is carried out by inhibiting ignition in all cylinders in 209, or in only some of the cylinders in 208, during the combustion inhibition sulfur regeneration action, the requested torque is continuously monitored, in order to determine whether the requested torque has changed so that the combustion inhibition sulfur regeneration action has to be changed or terminated.

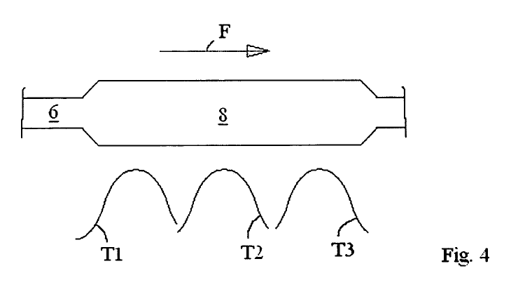

Reference is made to FIGS. 1 and 4. The method teaches controlling the throttle valve 10 so as to control the combustion in the catalytic converter 8 during the combustion inhibition exhaust gas treatment device regeneration. Based on the flow of fuel injected, the throttle is controlled so that a combustible air/fuel mixture is provided to the catalytic converter.

Referring to FIG. 4, in which a gas flow direction is indicated with an arrow F, the throttle valve 10 is also used during the regeneration to control the location of a maximum temperature in the exhaust gas treatment device. By controlling the throttle valve 10 so that a relatively small air flow is provided, the air/fuel mixture will be combusted relatively far upstream in the catalytic converter 8. As a result, the temperature distribution in the catalytic converter, indicated in FIG. 4 with the curve T1, will present a maximum relatively far upstream. By controlling the throttle valve 10 so that larger air flows are provided, the air/fuel mixture will be combusted further downstream in the catalytic converter 8. As a result, the temperature distribution in the catalytic converter, T2, T3, will present maximums further downstream, depending on the air flow. In other words, increasing the air flow will move the maximum temperature downstream.

Thus, the location of the maximum temperature can be changed, during the sulfur regeneration, which in turn makes it possible to obtain a particularly thorough regeneration, since it can be secured that the temperature is increased sufficiently for sulfur deposit removal throughout the entire catalytic converter.

As an alternative to, or in addition to a throttle valve 10, the air flow control means can comprise control means (not shown) for the inlet valve(s) 5 and/or the exhaust valve(s) 7, for example in the form of a variable valve timing (VVT) system and/or a cam profile shifting (CPS) system. Such inlet and/or exhaust valve control means can be used as an alternative or in addition to the throttle valve 10 for controlling the combustion in the catalytic converter 8 during the combustion inhibition exhaust gas treatment device regeneration.

Besides exhaust gas treatment device poisoning caused by sulfur, the invention is equally applicable to poisoning caused by other substances, such as phosphorus. In particular, the invention results in the catalyst average temperature being kept higher, and as a result, long term phosphorus poisoning can be reduced.

1. A method for regenerating an exhaust gas treatment device for an internal combustion engine having at least one cylinder, comprising:
inhibiting combustion in at least one of the engine cylinders; and
injecting fuel into at least one of the cylinders in which combustion is inhibited.

2. A method for regenerating an exhaust gas treatment device for an internal combustion engine having at least one cylinder, comprising:
in response to an operating condition, inhibiting combustion in at least one of the engine cylinders; and
injecting fuel into at least one of the cylinders in which combustion is inhibited.

3. The method as set forth in claim 2 wherein said operating comprises a level of device poisoning.

4. The method as set forth in claim 3 wherein said operating condition further comprises engine torque.

5. The method as set forth in claim 4 wherein said operating condition further comprises an engine torque.

6. The method according to claim 5 wherein the internal combustion engine comprises at least two cylinders.

7. The method according to Claim 6, wherein a number of engine cylinders into which fuel is allowed while combustion is inhibited is determined based on a temperature of the exhaust gas treatment device.

8. The method according to claim 7 wherein an amount of fuel allowed into the at least one of the cylinders in which combustion is inhibited is determined based on said temperature of the exhaust gas treatment device.

9. The method according claim 8, comprising adjusting an amount of airflow into the engine so as to control combustion in the exhaust gas treatment device during exhaust gas treatment device regeneration.

10. The method according to claim 9, wherein controlling combustion in the exhaust gas treatment device comprises controlling a location or a region of a maximum temperature in the exhaust gas treatment device.

11. An automotive system, comprising:
an internal combustion engine having at least one cylinder;
a fuel injection system adapted to supply fuel to said engine cylinders;
an exhaust gas treatment device adapted to receive exhaust gases from said internal combustion engine; and
an engine control unit adapted to control said engine and said fuel injection system, said engine control unit further adapted to inhibit, during exhaust gas treatment device regeneration combustion in at least one of engine cylinders and control, during exhaust gas treatment device regeneration, said fuel injection system so that fuel is allowed into at least one of the cylinders in which combustion is inhibited.
